(19) United States
(12) Patent Application Publication
(10) Pub. No.: US 2009/0127212 A1
(43) Pub. Date: May 21, 2009

(54) Chemical Cleaning Agent And Process For Cleaning Filtration Membranes

(76) Inventors: Heinz-Joachim Muller, New South Wales (AU); Dongliang Wang, New South Wales (AU); Fufang Zha, New South Wales (AU)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/067,969

(22) PCT Filed: Sep. 27, 2006
(86) PCT No.: PCT/AU2006/001409

§ 371 Date: Mar. 25, 2008

(30) Foreign Application Priority Data
Sep. 27, 2005 (AU) 2005905320

(51) Int. Cl. B01D 65/06; C11D 3/20

(52) U.S. Cl. 210/798; 210/797; 134/1; 510/109; 510/244

(57) ABSTRACT

Methods for cleaning a membrane, such a porous polymeric ultrafiltration or microfÊltration membranes (eg PVdF or Halar), comprising contacting the membrane with an aqueous solution comprising a monopersulfate anion. Buffers, chelating agents, catalysts, and combinations thereof can be added. The monopersulfate anion is most advantageously in the form of a potassium triple salt Of H₂SO₅, HSO₅⁻, SO₅²⁻. Solutions comprising monopersulfate anions can be fed into a feed side of the membrane and the membrane is allowed to stand and soak in the solution or injected to the filtrate side prior to a membrane backwash. An aeration step and/or irradiation with ultraviolet light can be used.

### TECHNICAL FIELD

The invention relates to compositions and processes for cleaning membranes, in particular to compositions and processes using monopersulfate compounds. The invention will be principally described with reference to the cleaning of hollow fibre polymeric microfiltration and ultrafiltration membranes, although it will be appreciated that it is applicable to a wide variety of membrane applications (including nanofiltration and reverse osmosis membranes), membrane compositions (including inorganic membranes) and membrane shapes (including tubular and flat sheet membranes) and is not limited to polymeric microfiltration and ultrafiltration membranes.

### BACKGROUND ART

Polymeric microfiltration and ultrafiltration membranes have found widespread use in the filtration of water. The porous microfiltration and ultrafiltration membranes commonly in use are typically in the form of hollow fibres, which are potted into bundles. The bundles are then set into modules, which can further be arranged into banks of modules. In this way, membrane surface area is maximised for a given volume, and large water throughputs can be achieved by apparatus having a relatively small “footprint”.

In some modes of operation, contaminated feedwater is introduced into the modules in such a way as to be allowed to contact only the outside of the hollow fibres. Passage of the water across the membrane may be by way of pressurisation or suction if necessary.

When the water passes through the hollow fibre polymeric membranes, it accumulates inside the lumen of the fibre, from where it can thus be drawn off and used. The contaminants remain on the outside of the hollow fibres.

As these contaminant materials build up on the filter they reduce the overall permeability of the membrane. Thus, the volume of water that passes through the membrane at a given pressure is reduced, or alternatively, the amount of pressure needed to sustain a given membrane throughput is increased. In either case, the situation is undesirable, as the membrane will soon cease producing clean water altogether, or will need to operate at pressures which risk destroying the integrity of the membrane. For this reason the membrane needs to be cleaned.

A large amount of the contaminant material can be removed from the hollow fibre by periodic backwashing, i.e. forcing a gas or filtrate through the inside lumen of the hollow fibre membrane in a direction contra to the flow of the water, such that the gas and/or the filtrate pushes contaminants from the membrane pores into the surrounding water which can be drawn off and sent, for example, to a settling pond or tank. Membranes can likewise be cleaned by other forms of mechanical agitation if desired. These other forms of agitation include aeration, ultrasonic vibration and shaking.

However, these mechanical and backwashing methods are not completely effective in removing all contaminant material and over time their efficacy gradually decreases as the membranes become fouled by material which is not so readily removed by these means. Because of the nature of the material being filtered, which is often surface water, ground water or material passing through membrane bioreactors and the like, the fouling agents are generally biological and/or organic in nature and usually contain foulants of an inorganic nature.

Chemical cleaning is usually necessary to fully remove foulants from membrane pores and surfaces. Because of the presence of more than one type of foulant (bio/organic foulants on the one hand, and inorganic foulants on the other), a dual chemical clean is usually required to fully recover the membrane's performance. An oxidant or caustic agent is used to remove organic foulants, and acids or chelating agents are used to remove inorganic materials fouling the membrane. The two cleans are carried out in series and normally take from four hours to two days to complete.

For example, polymeric microfiltration and ultrafiltration membranes fouled with biological or organic matter have typically been cleaned by the use of oxidative cleaning agents such as sodium hypochlorite (chlorine), hydrogen peroxide and to a lesser extent ozone. Inorganic matter is usually removed by the use of different acids. Grease, where present, can be removed by the use of caustic solutions and surfactants.

Chlorine is the most widely used cleaning agent however it is undesirable for widespread use as a water treatment chemical. Chlorine dosing in water treatment systems is a known cause of carcinogenic chlorinated organic by-products. These are hazardous and can create environmental disposal problems. Chlorine gas itself, as well as having an unpleasant odour, is also a health hazard to those in the area.

The use of hydrogen peroxide can avoid issues related to hazardous and environmentally unsound chlorinated by-products, but is generally less efficient as a cleaning chemical than chlorine.

Ozone is a more effective cleaning agent than chlorine or hydrogen peroxide, and also avoids many of the safety/environmental issues surrounding the use of chlorine. However membranes such as PVdF that resist oxidation by chlorine or peroxide are susceptible to degradation by ozone, as it is the more powerful oxidant.

Fenton's reagent has been used to clean membranes, and while effective, it is still desirable to provide an alternative which may be more suitable or convenient in certain situations.

Any discussion of the prior art throughout the specification should in no way be considered as an admission that such prior art is widely known or forms part of common general knowledge in the field.

It is the object of the present invention to overcome or ameliorate at least one of the above mentioned disadvantages of the prior art.

### DESCRIPTION OF THE INVENTION

According to a first aspect the invention provides a method of cleaning a membrane comprising contacting the membrane with a solution comprising monopersulfate anions.

Preferably the cleaning takes place at a pH optimal for cleaning the membrane, wherein the pH is controlled by way of a buffer.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

In preferred embodiments, the invention provides a method for cleaning a microfiltration or ultrafiltration or nanofiltration membrane comprising contacting the membrane with a solution comprising monopersulfate anions and an agent selected from:

a buffer, a chelating agent, a catalyst, a combination of a buffer and a chelating agent, a combination of a buffer and a catalyst, a combination of a chelating agent and a catalyst and a combination of a buffer, a chelating agent and a catalyst.

In one preferred embodiment, the invention provides a method for cleaning a microfiltration or ultrafiltration membrane comprising the step of contacting said membrane with solution comprising monopersulfate anions and a buffer.

Any buffer maybe used to control the pH and increase the stability of the monopersulfate precursor salts.

A chelating agent or catalyst may also be added.

In an alternative preferred embodiment, the invention provides a method for cleaning a microfiltration or ultrafiltration membrane comprising the step of contacting said membrane with solution comprising monopersulfate anions and a chelating agent.

A buffer or catalyst may also be added.

In an alternative preferred embodiment, the invention provides a method for cleaning a microfiltration or ultrafiltration membrane comprising the step of contacting said membrane with solution comprising monopersulfate anions and a catalyst.

A buffer or chelating agent may also be added

In an alternative preferred embodiment, the invention provides a method for cleaning a microfiltration or ultrafiltration membrane comprising the step of contacting said membrane with solution comprising monopersulfate anions, a chelating agent, a buffer and a catalyst.

The monopersulfate may be present alone or as a mixture of components H₂SO₅, HSO₅⁻, SO₅²⁻. Monopersulfate is supplied preferably as salts, such as the potassium or sodium salt. One particularly preferred source of monopersulfate is Oxone®.

The invention will also be described with reference to the use of one commercially available monopersulfate, Oxone®, a proprietary Du Pont product which contains a monopersulfate salt, a hydrogensulfate salt and a sulfate salt, in particular, potassium monopersulfate, potassium hydrogen sulfate and potassium sulfate. However, it would be appreciated again by those skilled in the art that any suitable solution of monopersulfate can be used.

The active ingredient in Oxone® is KHSO₅. Structurally, the hydrogen monopersulfate ion is represented as follows:

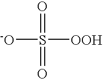

In solid form, Oxone® exists as a triple salt of formula 2KHSO₅.KHSO₄.K₂SO₄. The commercial Oxone blend includes KHSO₄ which can act as a buffer.

Without wishing to be bound by theory, it is believed that the oxone, in particular the active monopersulfate, acts to remove the organic foulants and biofoulants. The buffer is present to maintain optimum pH and may assist in removing inorganic foulants. The chelating agent, where present, is responsible for the removal of inorganic foulants. The catalyst, where present, acts to speed up the reaction and shorten the cleaning time required.

The concentration of Oxone® is from 0.01 wt % to 10 wt %, preferably 0.1 wt % to 10 wt % and more preferably 0.5 wt %-5 wt %, based on the amount of Oxone® salts dissolved in water.

The chelating agent is preferably citric acid. Other chelating agents, such as oxalic acid and EDTA can also be used. The concentration of chelating agent is from 0.1 wt % to 5 wt %, preferably 0.1%-3 wt %.

The catalyst can be present in order to facilitate the reaction rate. Preferred catalysts include metal ions, such as Fe²⁺, Cu²⁺, Ni²⁺, Co²⁺ etc. If used, a catalyst is preferably present in an amount of from 0.001 wt % to 0.1 wt %, more preferably 0.001 wt % to 0.01 wt %.

In another aspect, the invention provides a process for cleaning a membrane in need thereof comprising contacting said membrane with a solution comprising:
i) monopersulfate anions and
ii) an agent selected from a buffer, a chelating agent, a catalyst, a combination of a buffer and a chelating agent, a combination of a buffer and a catalyst, a combination of a chelating agent and a catalyst and a combination of a buffer, a chelating agent and a catalyst.

The solution may be fed into the feed side of membranes and the membranes allowed to stand and soak in the solution for a desired period, for example, several hours. In alternative preferred embodiments, the solution can be injected to the filtrate side in the backwash mode, or during repeated cycles of backwash and soaking.

The process can be conducted at a temperature of 1° C. to 50° C. A preferable temperature is from 5° C. to 40° C., most preferably from 10° C. to 40° C. An elevated temperature accelerates the reaction rate.

The cleaning time can be from 10 minutes to 24 hr. The most preferable cleaning time is from half an hour to 10 hours depending on the temperature of the solution. The clean time will decrease with increasing temperature of the solution. If the cleaning is carried out through backpulses, each backpulse can be from 1 to 300 seconds, more preferably from 5 to 120 seconds.

The pH preferably ranges from 1 to 9, more preferably 1 to 6 and is most preferably from 1.5 to 3.

The invention is described with reference to porous polymeric ultrafiltration or microfiltration membranes, however, it will be appreciated that it can be used on other classes of membranes such as nanofiltration membranes, gas filtration membranes or reverse osmosis membranes, or membranes with much larger pore sizes. It will also be appreciated that inorganic membranes. For example, ceramic membranes, may be cleaned with the compositions and methods of the present invention.

The microfiltration or ultrafiltration membrane can be made from any suitable oxidation resistant material, including but not limited to homopolymers, copolymers, terpolymers and the like, manufactured from any or all of the following fully or partially halogenated monomers including vinyl fluoride, vinyl chloride, vinylidene fluoride, vinylidene chloride, hexafluoropropylene, chlorotrifluoroethylene, and tetrafluoroethylene. Particularly preferred blends for microfiltration or ultrafiltration membranes are those made from polyvinylidene fluoride, i.e. PVdF, or blends of chlorotrifluoroethylene with ethylene, i.e. ECTFE (Halar) and polysulfones.

The contacting of the membrane with monopersulfate cleaning solution may occur alone or in combination with any other cleaning solution or method. A variety of methods are possible.

For example, the membrane may be soaked with the monopersulfate cleaning solution or have the monopersulfate cleaning solution filtered or recirculated through the membrane. The cleaning process may involve an aeration step, or a step of irradiating the solution with ultraviolet light to assist in cleaning. Further, the cleaning solution may be recovered after use if sufficiently active.

The cleaning methods of the present invention may be utilised in a variety of ways. The individual components may be added together, or separately, directly to the water which surrounds the fibre membranes. Alternatively, the source of iron ions may be from the feed water to be filtered.

Alternatively, the approach of the present invention may be used to take advantage of existing iron species which are present in the filtration water.

The monopersulfate cleaning solution system of the present invention may be passed through the membrane just once, or allowed to contact the membrane by standing for a time, or by repeated backwash-resting cycles, or recirculated through the membrane or membrane system. The contact time is preferably selected such that a predetermined level of cleaning is achieved, as demonstrated by membrane permeability.

If used, the catalyst may be recovered from the cleaning solution.

The invention may be applied to the filtration of surface water treatment, ground water treatment, desalination, treatment of secondary or tertiary effluent and membrane bioreactors.

The cleaning system of the present invention can be used in existing systems and treatment process to improve quality of feed, filtrate or the performance of the filtration process itself. As such, the clean may be done in a batch process, or in a continuous process, for instance, where the monopersulfate cleaning solution concentration immediately upstream of or at the membrane is measured, pH is adjusted and monopersulfate dosed in as appropriate to generate a predetermined concentration of monopersulfate at the membrane.

The cleaning methods are particularly suitable for cleaning in place (CIP) applications. Microfiltration and ultrafiltration membranes treated with the monopersulfate cleaning system of the present invention show improved recovery from fouling of membranes used for water filtration.

A dual clean is required in some CIP regimes. This involves both an acid clean (which may be an inorganic acid or, more usually an organic acid such as citric acid) to remove inorganic foulants and a chlorine clean to remove organic foulants. The use of the monopersulfate cleaning system of the present invention has the advantage of providing both an acid and an oxidative clean in a single process.

The cleaning agent and the cleaning process described in this invention are particularly useful for the applications where the use of chlorine is restricted.

### COMPARATIVE EXAMPLE 1

A module in a membrane bioreactor was allowed to become fouled by the normal flow of wastewater. The permeability fell to 62 LMH/bar. In accordance with normal processes, the membrane module was treated with 2% citric acid and the permeability rose to 118 LMH/bar. A first oxidative clean, with 1500 ppm Cl₂ raised the permeability to 180 LMH/bar. A second Cl₂ clean raised the permeability to 219 LMH/bar.

### INVENTIVE EXAMPLE 1

The same module in a membrane bioreactor was again allowed to become fouled by the normal flow of wastewater. The permeability fell to 84 LMH/bar. It was then soaked with a 2 wt % solution of oxone for 24 hours, which raised the permeability to 251 LMH/bar, an increase of close to 200%.

The method of the present invention thus achieved a significantly better result using a far simpler one step procedure than that known in the prior art. The process was conducted at room temperature.

Oxone is also cost efficient and is safe for operators to use. Because of its inherent safety, it is also easy to handle and can be used in existing systems without modification.

The results obtained suggest that there are no effects on the mechanical properties of membranes.

### COMPARATIVE EXAMPLE 2

A membrane module made of PVDF fibres was operated in a membrane bioreactor to filter mixed liquor. After three months filtration, the membrane module permeability declined to 75 LMH/bar due to fouling. A standard dual chemical clean in place (CIP) was performed with citric acid followed by chlorine. This resulted in the membrane module permeability recovering to about 130 LMH/bar.

### INVENTIVE EXAMPLE 2

The same module then continued to be operated in a membrane bioreactor to filter mixed liquor. After three months filtration, the permeability had dropped to 95 LMH/bar. The module was cleaned with a single 2% Oxone solution. The module permeability recovered from 95 to 180 LMF/bar.

Not only did the module permeability recovered to an improved level relative to the previous dual CIP, but the membrane fouling rate in the following filtration was also reduced.

After four months operation, a further clean with Oxone solution was carried out to confirm the cleaning efficacy. The permeability of the module was lifted from 150 to above 200 LMH/bar, confirming the effective cleaning with Oxone.

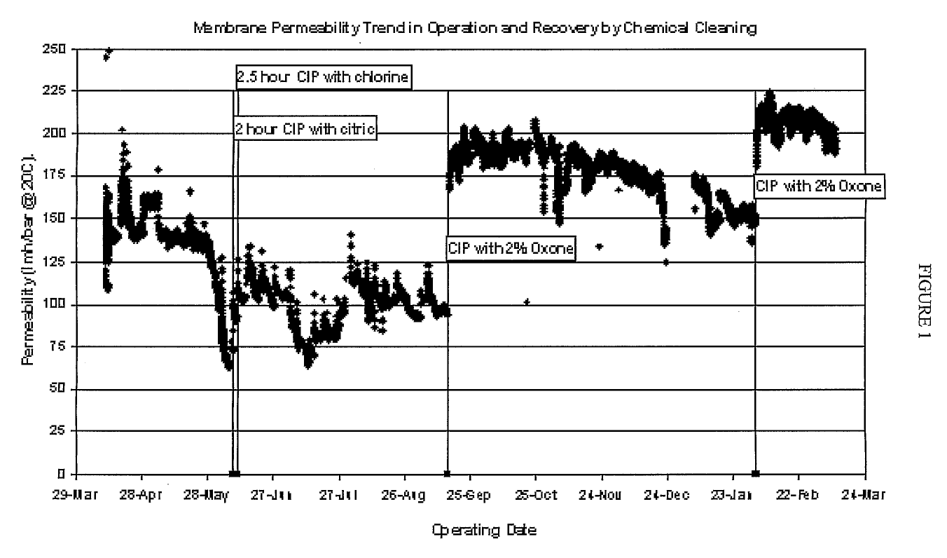

FIG. 1 shows the overall permeability trend and the recovery of each clean in Example 2.

1. A method of cleaning a membrane comprising contacting the membrane with an aqueous solution comprising a monopersulfate anion.

2. A method according to claim 1 wherein the membrane is a porous polymeric ultrafiltration or microfiltration membranes.

3. A method according to claim 2 wherein the membrane is an asymmetric membrane.

4. A method according to claim 2 wherein the membrane is made from a fully or partially halogenated monomer or mixture of monomers.

5. A method according to claim 4 wherein the membrane is made from a monomer or mixture of monomers including vinyl fluoride, vinyl chloride, vinylidene fluoride, vinylidene chloride, hexafluoropropylene, chlorotrifluoroethylene or tetrafluoroethylene.

6. A method according to claim 5 wherein the membrane is made from polyvinylidene fluoride (PVdF).

7. A method according to claim 5 wherein the membrane is made from a blend of chlorotrifluoroethylene with ethylene (Halar).

8. A method according to claim 5 wherein the membrane is made from a polysulfone.

9. A method according to claim 1 wherein the membrane is an inorganic membrane.

10. A method according to claim 9 wherein the membrane is a ceramic membrane.

11. A method according to claim 1 comprising contacting the membrane with an aqueous solution comprising a monopersulfate anion and an agent selected from: a buffer, a chelating agent, a catalyst, a combination of a buffer and a chelating agent, a combination of a buffer and a catalyst, a combination of a chelating agent and a catalyst and a combination of a buffer, a chelating agent and a catalyst.

12. A method according to claim 11 comprising the step of contacting the membrane with an aqueous solution comprising a monopersulfate anion and a buffer.

13. A method according to claim 11 wherein the buffer is HSO₄⁻.

14. A method according to claim 11 comprising the step of contacting said membrane with a solution comprising a monopersulfate anion and a chelating agent.

15. A method according to claim 14 wherein the chelating agent is citric acid.

16. A method according to claim 14 wherein the chelating agent is oxalic acid.

17. A method according to claim 14 wherein the chelating agent is EDTA.

18. A method according to claim 11 comprising the step of contacting said membrane with solution comprising monopersulfate anions and a catalyst.

19. A method according to claim 18 wherein the catalyst is a metal ion.

20. A method according to claim 19 wherein the catalyst is selected from Fe²⁺, Cu²⁺, Ni²⁺, Co²⁺.

21. A method according to claim 19 wherein the metal ion is comprised in a cleaning solution.

22. A method according to claim 19 wherein the metal ion is present in feedwater to be filtered.

23. A method according to claim 1 wherein the monopersulfate is present alone or as a mixture of components H₂SO₅, HSO₅⁻, SO₅²⁻.

24. A method according to claim 23 wherein the monopersulfate is in the form of a potassium or sodium salt.

25. A method according to claim 1 wherein the monopersulfate further includes a hydrogensulfate salt and a sulfate salt.

26. A method according to claim 25 wherein the monopersulfate is provided by a triple salt of formula 2 KHSO₅.KHSO₄.K₂SO₄.

27. A method according to claim 1 wherein the solution comprising monopersulfate anions is fed into a feed side of the membrane and the membrane is allowed to stand and soak in the solution.

28. A method according to claim 1 wherein the monopersulfate solution is injected to the filtrate side prior to a membrane backwash.

29. A method according to claim 1 wherein the cleaning is conducted in a pH ranges of from 1 to 9.

30. A method according to claim 29 wherein the pH range is from 1 to 6.

31. A method according to claim 1 wherein the pH range is from 1.5 to 3.

32. A method according to claim 1 wherein the monopersulfate cleaning solution is filtered through the membrane, recirculated through the membrane or allowed to stand in contact with the membrane.

33. A method according to claim 1 further including, prior to, concurrently with or after monopersulfate cleaning, an aeration step, or a step of irradiating with ultraviolet light.

34. A method according to claim 1 wherein the cleaning is conducted for a predetermined time such that a predetermined level of cleaning is achieved, as orated as demonstrated by membrane permeability.

35. A method according to claim 1 carried out as a batch process, or in a continuous process.
